(19) United States
(12) Patent Application Publication
(10) Pub. No.: US 2025/0022048 A1
(43) Pub. Date: Jan. 16, 2025

(54) APPLICATION OF NATURAL LANGUAGE PROCESSING TO NOTATIONAL DATASETS TO ENHANCE SUB-THRESHOLD REMEDIATION

(71) Applicant: Wells Fargo Bank, N.A., San Francisco, CA (US)

(72) Inventors: Stacy Renee Henryson, Clive, IA (US); Richard Penfil, II, San Antonio, TX (US)

(21) Appl. No.: 16/993,021

(22) Filed: Aug. 13, 2020

(51) Int. Cl. G06Q 40/02; G06F 3/12; G06F 16/28; G06F 16/583; G06F 40/30; G06K 9/46; G06K 19/06; G06Q 10/08; G06Q 10/10; G06Q 20/04

(52) U.S. Cl. CPC G06Q 40/02; G06F 3/1296; G06F 16/285; G06F 16/5854; G06F 40/30; G06K 19/06037; G06Q 10/083; G06Q 10/107; G06Q 20/0425; G06V 30/18; G06V 30/10

(57) ABSTRACT

Disclosed are methods, systems, and devices for detecting and correcting a sub-threshold remediation, wherein a remediation threshold may be established to meet a target remediation execution rate. A remediation may be categorized according to various cause codes by natural language processing, as well as optical recognition, or other methods of machine learning, which may aid in categorization. A plurality of remediation thresholds may be determined according to any characteristic of a transferee, including a history of remediation execution, a status, and the cause code of the remediation.

### TECHNICAL FIELD

The present disclosure relates generally to the application of natural language processing to a notational database containing text entries to determine a cause code associated with a sub-threshold remediation from the text entries, associate an applicable threshold, and intervene by substituting a remediation compliant with the associated threshold.

### BACKGROUND

Remediation transfers may be conveyed to a transferee in a form that requires some action on the part of the transferee to execute the remediation. In some instances, a transferee may fail to execute the remediation, particularly when the remediation may be viewed as negligible. A non-execution on the part of the transferee may impose burdens on the transferor, such as data coherency issues, maintenance costs, audit costs, etc. Moreover, a transferor may not readily know which remediation efforts are of a type which is likely to burden it in the event that a transferee fails to execute the remediation. In some cases, the lack of ready knowledge may relate to a surplus of information, including information not easily searched, rather than the lack of information.

### SUMMARY OF THE INVENTION

One embodiment of the invention relates to a system including a payment information database which includes a planned payment of an initial payment amount to a transferee, an account information database which includes account information of the transferee, and a notational database including text entries encoded to correlate with the account information database, or the payment information database. The system further includes a computing device including a processor and a memory, which are configured to determine a minimum redemption threshold, categorize the planned payment as subject to the minimum redemption threshold which is based on a data processing operation (comprising natural language processing) performed on the notational database. The computing device is also configured to determine the initial payment amount is less than the minimum redemption threshold, and that the payment involves a printable payment instrument, as well as associate a transferee (at a transferee address) with the payment, and convey the payment to the transferee.

Some implementations may involve a system including a payment information database with a planned payment of a transferee and an initial payment amount to the transferee, an account information database comprising account information of the transferee, and a notational database including text entries encoded to correlate with the account information database, or the payment information database. The implementation may include determining a minimum redemption threshold, performing a data processing operation including natural language processing on the text entries in the notational database to determine a cause code. The embodiment may also include categorizing the applicability of the minimum redemption threshold to the planned payment based on the cause code, determining the initial payment amount of the planned payment is less than the minimum redemption threshold, identifying the planned payment is intended to be conveyed via a printable payment instrument, generating the printable payment instrument, and conveying the printable payment instrument to the transferee at the transferee address.

Additional embodiments include a non-transitory computer readable medium, having stored thereon instructions that when executed by a computing device, cause the computing device perform actions including: determining a minimum redemption threshold, performing a data processing operation including natural language processing on the text entries in the notational database to determine a cause code. The embodiment may also include categorizing the applicability of the minimum redemption threshold to the planned payment based on the cause code, determining the initial payment amount of the planned payment is less than the minimum redemption threshold, identifying the planned payment is intended to be conveyed via a printable payment instrument, generating the printable payment instrument, and conveying the printable payment instrument to the transferee at the transferee address.

### BRIEF DESCRIPTION OF THE DRAWINGS

FIG. 1 depicts a block diagram of an illustrative example system in accordance with various potential embodiments.

FIG. 2 depicts an illustrative redemption rate curve in accordance with various potential embodiments.

FIG. 3A depicts an illustrative transferee letter associated with a payment in accordance with various potential embodiments.

FIG. 3B depicts an illustrative user presentment interface in accordance with various potential embodiments.

FIG. 4 is a flow diagram depicting an illustrative method in accordance with various potential embodiments.

### DETAILED DESCRIPTION

Various embodiments described herein relate to systems, methods, and devices for identifying a scheduled remediation through natural language processing on data in a notational database, comparing the remediation amount to a remediation threshold, categorizing the scheduled remediation, modifying the remediation to accord with the remediation threshold, and conveying the modified remediation to a transferee. In certain embodiments, the remediation may relate to payments made by a bank or other financial institution, and the remediation threshold may comprise a minimum payment amount a transferee can be expected to execute at a desired rate. Such an embodiment may comprise the steps of identifying an initial payment amount, comparing the initial payment amount to a minimum redemption threshold, categorizing a planned payment associated with the initial payment amount according to the applicability of the minimum redemption threshold, and conveying the minimum redemption threshold amount to a transferee via a printable payment instrument. A printable payment instrument may be a check that is printed and delivered (e.g. by a financial institution), and/or an electronic record capable of being printed (e.g. a pdf), or another printable payment medium (e.g. a standard barcode or quick response “QR” code) which may be redeemed by, for example, a mobile wallet.

In some embodiments, conveying the printable payment instrument to the transferee may comprise the actual delivery (e.g. by a transferor courier) but in many cases, conveying the printable payment instrument may be accomplished without literal delivery. For example, sending a printable payment instrument by email to a transferee is conveying the printable payment instrument to the transferee, even if an intermediate server processes or forwards the email between the transferor and the transferee. Similarly, posting a letter to a transferee also conveys the printable payment instrument, even where an intermediary of a postal carrier may make a physical delivery of the printable payment instrument (e.g. check). It is not necessary that the transferor physically or digitally maintain the printable payment instrument through every step of the conveyance process to be a conveyance. In many cases, an intermediate party may be involved in the delivery process (e.g. third party email servers, postal services, common carriers, etc.). Conveyance may be accomplished by, for example, delivering a letter to a letter carrier, posting a letter, electronically transferring a file to be printed, or sending an email which may be ultimately received by a transferee.

Although modern databases contain large amounts of information, differing formats, human input, reliance on third party data, etc. may make data cohesion and compliance difficult across large datasets. For example, an entity may not track a redemption rate of certain remediation payments because it operates in a regulatory environment that does not require any such audit. However, upon the change of a regulatory requirement, the change of a business plan (e.g. entering a new market), an acquisition by another entity, etc., an elevated reporting requirement may be imposed. For example, a financial institution may track the redemption of remediation payments due to “bank error” to comply with internal controls, regulatory requirements, pending litigation, etc. If the regulatory requirement or the internal control is imposed requiring the financial institution to report bank errors based on late fees erroneously assessed on women owned businesses with assets less than $3 million, the financial institution may not have the information to immediately comply. In some embodiments, the bank may possess large amounts of information (account notation, external databases indicating business ownership, etc.) which may make it possible to determine, or at least approximate the number of remediation payments, their redemption rates, etc. However, available records may be of differing format, and in some cases, may not be contained in atomic entries, but be captured in large text entries, images (e.g. tiff files, jpegs, pdf files), etc. Even where information is available in a human readable-form, it may not be practicable for a person to review the records to make any determinations.

In some instances, it may be useful to attribute a cause code to a payment, such as a remediation payment. In some instances, an adequate cause code may be assigned at the time that a remediation payment is originated, or planned. For example, if a financial institution is aware of a (e.g. regulatory) requirement to track remediation payments for bank errors based on late fees erroneously assessed on women owned businesses with assets less than $3 million, then a dedicated cause code may be assigned, and the financial institution may not need to categorize the transaction based on text in a notification database. However, in some cases, an entity may need to determine a categorization that did not previously exist, or audit information that has been previously provided a cause code such as to ensure compliance with coding standards. In some embodiments, text relevant to categorizing a transaction may exist in a third party database. For example, a database held by a credit bureau. In some cases, the use of a natural language processing (“NLP”) engine may enable a categorization to be transferred without transferring proprietary or personally identifiable information. For example, a database may contain detailed financial records of a customer's interaction with a third party financial institution. The third party may not share details of the database for business or regulatory reasons, however, it may allow a search of data with a result that may not reveal confidential data (such as a Boolean result confirming a state of residency). In some cases, the use of an NLP engine to return an allowable search result may be useful operating across regulatory regimens and may enable determination while maintaining data privacy (e.g. California Consumer Privacy Act, General Data Protection Regulation).

A cause of a payment, such as a remediation payment, may be according to any categorization. For example, a financial institution may charge a fee based on six months of account inactivity, and may inadvertently design their system to charge such a fee after 180 days of activity (which may be less than 6 months for some periods of time). In some embodiments, the cause code may be linked to the root cause of the particular design error. In other cases, the cause code could include any erroneous inactivity fee (regardless of the root cause). In some embodiments, each business unit or account type may have a unique cause code for a single root cause, and in other embodiments, multiple root causes and effects may be combined into a single cause code. For example, all banking errors may be assigned the cause code “banking error.” In some embodiments, the remediation may not be associated with a bank error. For example, a transferee may close an account while funds are pending, and may not be released to the customer at that time. Upon the funds clearing, the funds may need to be transferred to the account holder, but since the account holder has closed his or her account, he or she may need to provide a payment to the customer (e.g. by a check).

Natural language processing (NLP) provides one possible avenue to garner information from large datasets. In instances where information is stored as an image, optical character recognition (OCR) may enable NLP of image based text. Optical recognition may operate on a physical document, such as with a camera, or on a file, such as a pdf or tiff image. Beneficially, optical recognition may be able to capture more than individual entries of text. For example, optical recognition may be able to determine zones such as a salutation zone, an account number zone, etc. For example, although an OCR program alone may not distinguish between “BOB” and “808,” the identification of zones as a secondary indicator may aid the system by, for example, increasing the chance of locating numeric numbers in an account field, or alphabetic characters in a salutation field. With or without the use of optical recognition, an NLP engine may determine zones of information. For example, a NLP may recognize an address based on whitespace (which may, in some instances by determined by carriage returns, tabs, or other digital representations of white space) surrounding the address. Similarly, an NLP engine may associate account balances with dollar signs or two decimal point numbers, and may associate names as following a salutation (e.g. Mr., Ms., Dr., etc.) or based on the presence of a middle initial. In some embodiments, an NLP engine may be a part of a machine learning engine. In some embodiments, the NLP engine may take advantage of machine learning to process text. In some embodiments, the machine learning engine may additionally determine documents (e.g. documents in the notational database) which are likely to contain information minable by the NLP, or may determine a probability of an association with an account, address, name, etc.

In an example alternative embodiment of the above platform, illustrative of its potential applicability and functionality, the remediation may relate to, for example, QoS (Quality of Service) in a network, and remediation transfers may comprise data associated with a data-stream, and the remediation threshold may comprise a minimum file size, or minimum payload of a packet accepted by a transferee network interface. In such an embodiment, a notational database may comprise a log-file containing plurality of acknowledgements, resend requests, framer orderings, etc. In some cases, a remediation payload may need to be associated with a frame number.

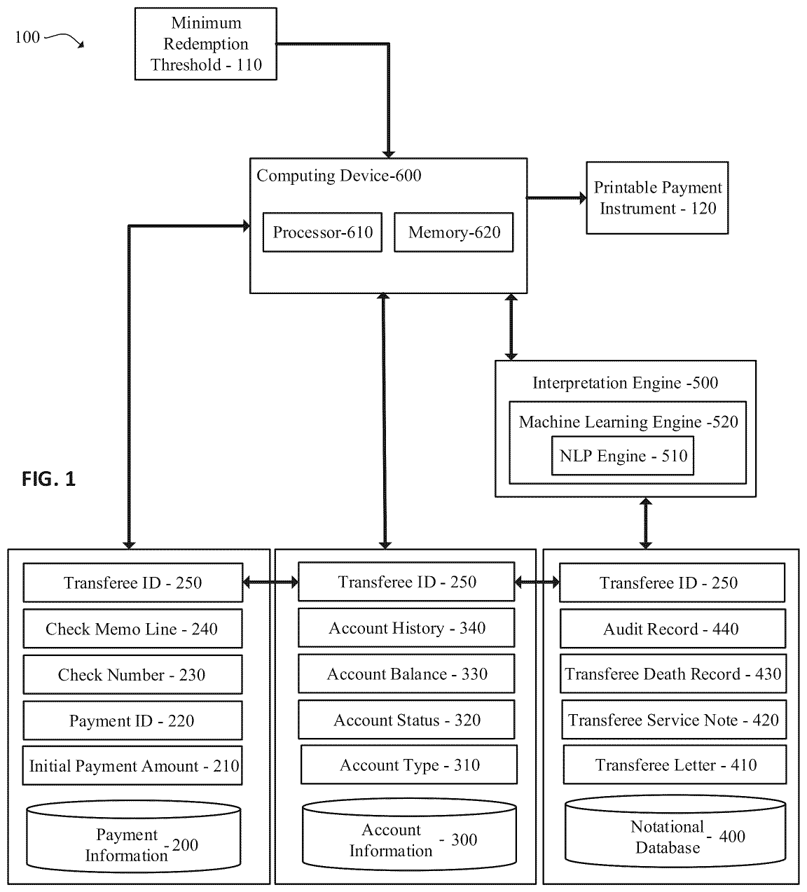

Referring to FIG. 1, a block diagram of a system 100 enabling detection and/or correction of payments below a minimum redemption threshold 110, according to potential embodiments, is depicted. The system 100 includes a payment information database 200 which contains details of payments which are planned, scheduled, or contemplated. For each payment, the payment information database 200 may include an initial payment amount 210. The initial payment amount 210 is a payment amount which may be disbursed without consideration of the minimum redemption threshold 110. In some embodiments, the initial payment amount 210 may be ready for disbursal, excepting the comparison to the minimum redemption threshold 110. In other cases, the initial payment amount 210 may still need to undergo further processing. For example, in some cases, the initial payment amount 210 may need to undergo a fraud detection test, an offsetting overdraft test, or otherwise be adjusted (such as by the addition of interest earned in a period). The payment information database 200 may further include a payment ID 220. In one embodiment, the payment ID 220 may be a sequential number generated in the order that the payment was processed. In other embodiments, the payment ID 220 may incorporate any other information. For example, the payment ID 220 may incorporate information pertaining to an account type 310, a processing date, a customer identifier, etc. In some embodiments, the payment ID 220 may be synonymous with a check number 230. In other embodiments, a separate check number 230 may be generated. The check number 230 may be generated sequentially, or may be determined based on encoded information. In other embodiments, the payment ID 220 may be displayed as a check memo line 240. In some embodiments, the payment ID 220 may be based on a transferee ID 250. The transferee ID 250 may comprise any data that may identify a transferee (e.g. a name, an address, an account number, a social security number or tax identification number, an account balance 330, etc.). In some embodiments the transferee ID 250 may be unique to each transferee (e.g. a social security number as the transferee ID 250). In other embodiments the transferee may not be unique to each transferee ID 250 (e.g. the name or the state of residence of the transferee). In cases where a single element of the transferee ID 250 is not unique to a transferee, a plurality of elements may be used to uniquely identify the transferee. For example, where neither the name of the transferee, nor the address of the transferee may individually identify the transferee, the combination of the name and the address may uniquely identify the transferee.

An account information database 300 may contain information regarding an account type 310. In some embodiments, the account type 310 may be categorized as a checking account, a savings account, a mortgage account, a credit card account, or another account type 310. In some embodiments, the account type 310 may comprise account information detailing whether an account holder is a student, senior citizen, high value client, or other information. In some embodiments, the account type 310 may be relevant to determining fees or interest charges associated with an account. For example, a student checking account may be exempted from minimum balance fees, and a brokerage margin account may have an interest rate associated with it based on the account type 310. Some embodiments of the account information database 300 may include data on whether an account is generated online, over the phone, at a retail location, or other categorization information as a part of the account type 310. The account information database 300 may also include information on an account status 320. The account status 320 may include information as to whether an account is open, closed, on hold, etc. The account information database 300 may also contain information on an account balance 330. The account balance 330 may comprise information on the balance of funds in the account, the balance of funds available in the account, any pending transactions associated with the account, etc. An account history 340 may include any past account or transactional information. For example, the account history 340 may include data indicating that the account was previously on hold, previously overdrawn, or previously included a senior citizen as an account holder. The account history 340 may be beneficial to determine the propriety of certain account actions. For example, if an account holder was a senior citizen for a prior billing period or at the opening of a current billing period, a minimum balance fee may be improper for either (or both) of the billing periods. Likewise, if an average daily balance for a previous period or a current period is below a balance threshold, a low balance fee may be appropriate, without regard to the current account balance 330.

The account information may also include the transferee ID 250. In some cases, the transferee ID contained in the account information database 300 may be identical to the transferee ID 250 contained in the payment information database 200. For example, in some embodiments, an account number may be included in both the payment information database 200 and the account information database 300. In some embodiments, variations of the same data may be contained in the payment information database 200 and the account information database 300. For example, the two databases might both contain a first and last name, but one database might include a middle initial, and the other database might lack a middle initial. Similarly, one database may include an account number stored as a string, while the other database may contain the same account number stored as an integer. In some embodiments, the string may include formatting not included in the integer, such as dashes or spaces. In other embodiments, the databases may include conflicting information. For example, a name change or address correction may be reflected in one database, but absent from the other. The transferee ID 250 in the account information database 300 may comprise any data in the account information database 300. For example, an account type 310, or account balance 330 could be matched to information in the payment information database 200 in order to identify a transferee. Further, the account history 340 may be used to identify a transferee, such as in the case of a name change.

A notational database 400 includes records related to an account or a transferee which contains text entries. The text entries may be computer generated, human generated, or some combination thereof. In some embodiments, a transferee letter 410 may be generated to inform a transferee that an account has been closed, that some other action has been taken, or to inform a transferee of routine information during a period (such as a monthly or quarterly statement). The notational database 400 may also include a transferee service note 420. The transferee service note 420 may include any text relevant to a transferee. For example, a notation entered by a customer service agent (e.g. a request to close an account, or a query regarding an imposed fee) may be stored in the notational database 400 as a transferee service note 420. In some instances, a notation submitted by a transferee may be entered as a service note. The transferee service note 420 may comprise a transferee email, or the contents of a conversation with a transferee over an instant messaging program. The notational database 400 may also include records such as a transferee death record 430 or an audit record 440. A death record of a person who is not the transferee may still be considered a transferee death record 430 so long as the death record is relevant to or associated with the transferee. An audit record 440 may contain results of an audit, or an account note concerning an audit result or a scheduled audit. For example, an audit record 440 may indicate that an audit is planned for the account. In some embodiments, an audit record 440 may indicate that information has been audited and determined to be verified as accurate. In some embodiments, the audit record 440 may indicate a possibility of an account discrepancy, or details on a confirmed discrepancy that may (or may not) require remediation. In some embodiments the notational database 400 may also contain information most closely associated with a non-transferee. When such information is relevant to or associated with a transferee, it may be understood to be transferee data. For example, in the example of a payable on death (“POD”) account, a letter sent to a deceased account holder (who is not the transferee) or may contain information relevant to the transferee. Such a letter may be considered to be a transferee letter 410.

The notational database 400 may also contain the transferee ID 250, which may be used to link information in the notational database 400 to any other database. For example, the transferee ID 250 may comprise an account number, an address, a name, or other information present in the notational database 400. In some embodiments, the transferee ID 250 may comprise a dedicated field. For example, an account number may be stored in an account number field in the notational database 400. Alternatively, the transferee ID 250 could be contained within a text record. For example, an account number may be contained in the body of the transferee letter 410. In some embodiments, the transferee ID 250 may comprise information from a plurality of text records. For example, a transferee name could comprise a surname, and a forename, wherein the surname could be located in a transferee letter 410 (e.g. “Dear Mr. Smith . . . ”) and the forename could be comprised within a portion of an instant message exchange, or a transcript of a voice call (e.g. “call me ‘John’”).

In various embodiments, text entries and other data in notional database 400 may be encoded to link, correspond, or associate the data to account information in the account information database 300 (e.g., to a specific transferee or data associated therewith) and/or to planned payment information in the payment information database 200. In certain embodiments, for example, a text entry or other data in the notional database 400 may be assigned or encoded with a unique identifier, and to link or associate certain other data in the account information database 300 and/or certain other data in the payment information database 200, that certain other data may also be assigned or encoded with the same unique identifier. Alternatively or additionally, a text entry or other data in the notional database 400 may be assigned or encoded with a first unique identifier, particular data in the payment information database 200 may be assigned or encoded with a second unique identifier, and particular data in the account information database 300 may be assigned or encoded with a third unique identifier, and to link or associate the data in the three databases, a dataset may be generated (e.g., as part of one of the databases 200, 300, or 400, or as part of a separate database) that indicates there are one or more associations or linkages between or among the first unique identifier, the second unique identifier, and/or the third unique identifier.

The system 100 may also comprise an interpretation engine 500. The interpretation engine 500 may comprise a machine learning engine 520, which may comprise an NLP engine 510, capable of extracting information from a text field. The interpretation engine 500, machine learning engine 520, and/or NLP engine 510 may be applied to various data found in payment information database 200, in account information database 300, and/or in notational database 400. For example, the NLP may be able to recognize, and extract an address from the header of a transferee letter 410, and in some cases, convert the address into a machine readable data type which may be used for comparison or linkage with another address. For example, another database within the system 100 may contain type codes for street types, wherein the number ‘7’ corresponds to an avenue. The NLP engine 510 may identify text formatted as an address, and then find the string “Ave.” within the text, at a location interpreted to be a street type. The NLP engine 510 may store the street type as ‘7,’ for later comparison or processing. In various embodiments, the interpretation engine 500 may be used on, for example, check memo line 240 or other data from the payment information database 200. In some embodiments, the machine learning engine 520 may process data which is input into the NLP engine 510 (such as determining what records are likely to contain transferee ID 450 which may be used to correlate the data to other databases). In some embodiments, the machine learning engine 520 may be used to process data output from the NLP engine 510 (such as to determine a probability of a correct match based on the NLP engine 510 output). In some embodiments, the interpretation engine 500 may comprise optical character recognition, which can recognize characters from an image or an image file, or other optical recognition capability, which may recognize symbols, whitespace, handwriting cues, etc.

A computing device 600 may be configured to receive a minimum redemption threshold 110. In some embodiments, the minimum redemption threshold 110 may be a single value for all cases, such as $5.00. In other embodiments, the redemption amount may be a different value according to data associated with each payment. In some embodiments, the computing device 600 may determine the minimum redemption threshold 110 based on an external source, such as from a user entry field. In other embodiments, the computing device 600 may determine the minimum redemption threshold 110 from a computational process. For example, the computing device 600 may receive an input that at least 80% of payments should be redeemed, and the computing device 600 may determine a minimum redemption threshold 110 based on that input.

The computing device 600 may access the payment information database 200, the account information database 300, and the notational database 400 in order to categorize a planned payment as subject to the minimum redemption threshold 110. In one embodiment, the payment information database 200 may include a payment reason. The payment reason may recite a cause code which the computing device 600 may use in categorizing the payment. In some embodiments, this may be a dedicated database field. In some embodiments, the computing device 600 may determine this information based on another source, such as on check memo line 240. In some embodiments, the payment information database 200 may comprise an account number from which the payment is drawn. This account number may be used by the computing device 600 to categorize the payment as subject to the minimum redemption threshold 110. For example, if every payment dawn from a first account is subject to the minimum redemption threshold 110, then the computing device 600 may determine the categorization based on an account number. If no payment drawn from a second account is subject to minimum redemption threshold 110, computing device 600 may determine the categorization based on the account number. In other cases, the computing device 600 may use the account number (or any other information) as a part of a probabilistic model. For example, if payments drawn from a third account are very rarely used to issue payments subject to the minimum redemption threshold 110 for transferees who do not have California mailing addresses, then a probability of the payment drawn from the third account being subject to the minimum redemption threshold 110 to a transferee in Vermont may be adjusted downward.

The initial payment amount 210 of the planned payment may be compared to the minimum redemption threshold 110. In some embodiments, the comparison may be based on a categorization. For example, if an interest error on a checking account has a minimum redemption threshold 110 of $5.00, a date calculation error on an auto loan has a minimum redemption threshold 110 of $10.00, and an overpayment error on an auto loan has no minimum redemption threshold 110, a planned payment of $7.00 to remedy a date calculation error on an auto loan may be found to be subject to (and less than) the minimum redemption threshold 110. In some embodiments, the computing device 600 may need to access the account information database 300 to categorize the payment type. For example, the computing device 600 may need to access the account type 310 or the account history 340 information in order to categorize the payment. In some embodiments, the computing device 600 may need to access any other part of the account information database 300. In still further embodiments, the computing device 600 may access data from the notational database 400. For example, if the transferee letter 410 has been generated to accompany the planned payment, then the transferee letter 410 may contain information that, when interpreted (e.g. by the NLP engine 510 or the machine learning engine 520) may be used to categorize the account.

The computing device 600 may also be configured to determine a method of payment. For example, the payment device could determine that a planned payment is scheduled to be transferred into the checking account of a transferee. Because a risk of non-redemption of the planned payment conveyed by an electronic transfer may be lower than a physical payment, the computing device 600 may be configured to allow any electronic transfer to a checking account without regard to the minimum redemption threshold 110. In alternative embodiments, the computing device 600 may be configured to treat only certain checking accounts (e.g. checking accounts serviced by U.S. based institutions, checking accounts serviced by the transferor, or checking accounts held by selected partners) without regard to the minimum redemption threshold 110. In some embodiments, these minimum redemption threshold 110 applicability rules, or any other minimum redemption threshold 110 applicability rules may be uniform across all account types 310, or non-uniform across account types 310.

In one embodiment, the minimum redemption threshold 110 may apply only to a printable payment instrument 120 (such as a check, money order, etc.) In some instances, a printable payment instrument 120 may be printed, and conveyed (as a tangible payment instrument) to the transferee. In other embodiments, the printable payment instrument 120 may be an electronic file of a format suitable for printing, and submission for payment. For example, a pdf or tiff image including a check may be categorized as a printable payment instrument 120, where the transferee could print the file into a usable form. In some instances, a transferee may optionally use the electronic file to electronically submit a payment (such as through a mobile banking application) however, the method that a transferee actually uses to redeem the payment instrument is not dispositive, so long as the printable payment instrument 120 is capable of being printed.

The system 100 may convey payment to the transferee via the printable payment instrument 120. In some embodiments, the printable payment instrument 120 may be the check (including a cashier's check, money order, personal check, certified check, etc.). In some embodiments, the system 100 may be configured to convey the check through the mail or a common carrier. In other embodiments, the system 100 may convey the check or another printable payment instrument 120 electronically (such as a QR code which may be printed and scanned to receive a payment). In some embodiments, the method of conveyance may impact the redemption rate. For example, a check conveyed to the transferee via overnight federal express, may have a higher redemption rate than an identical check conveyed to the transferee via third class mail, e-mail, or another conveyance service. In some embodiments, the computing device 600 may determine the minimum redemption threshold 110 based on the conveyance service and/or determine the conveyance service based on a target redemption rate.

The computing device 600 is also configured to transfer excess payment funds to fund the minimum redemption threshold 110. For example, if an account has been closed with a balance of $0.05, and the minimum redemption threshold 110 is $3.50, then the computing device 600 may provision at least $3.45 to enable the payment to be made. In some embodiments, this provisioning may take place on a payment by payment process. In other embodiments, the provisioning may take place as a batch process wherein the funds are transferred for a plurality of planned payments at one time. In some embodiments, the provisioning may take place as a stream process, such as on a daily basis based on previous redemptions, expected redemptions, or possible redemptions. In some instances, the transfer may move funds to the account which contains the initial payment amount 210. For example, in the previous example, the additional $3.45 may be added to the account with the balance of $0.05 resulting in the account containing at least the minimum redemption threshold 110. Advantageously, such an embodiment may allow a person to view the account history 340 and excess funds transfer for one account without accessing multiple accounts. In other instances, a separate account may be used for payments to transferees implicating the minimum redemption threshold 110. For example, $3.50 could be transferred to a separate account in order to enable a payment of the minimum redemption threshold 110 drawn from the separate account. Beneficially, such an embodiment may allow a person to view a plurality of transfers (such as all transfers relating to a common root cause) without accessing multiple accounts.

In some embodiments (e.g. a batch transfer), the transfer may be made as a part of a campaign affecting a plurality of accounts. In some embodiments, a campaign affecting 100 accounts may result in a transfer of 100 times the minimum payment (e.g. for a $3.50 minimum redemption threshold 110, $350 could be transferred). Alternatively, a different amount may be transferred. For example, if an average balance of $0.50 is expected across 100 accounts, then $300 could be transferred. In some cases, the different amount could exceed the full minimum payment. For example, if 100 accounts have a negative average balance, such as −$0.10, and a further $0.65 processing charge is associated with providing a printable payment instrument 120 (and without regard to whether this $0.65 processing charge is internally assessed by a payee, or a charge from an external vendor) then the transferor may transfer $425 to provision for the minimum redemption threshold 110.

($3.50−(−0$0.10)+$0.65)×100=$425

In another embodiments, funds may be transferred based on an anticipated or maximum redemption amount. In one example, where 100 checks are conveyed to transferees, and each check is for the minimum redemption threshold 110 of $5.00, and an expected redemption rate is 80%, the system 100 may transfer $500 ($5×100), $400 ($500×100×0.80), or any other amount. In one embodiment, the system 100 could transfer an amount greater than the expected redemption amount, and less than the maximum redemption amount. This may be based on a safety margin, which may be fixed or dynamic, and may be based on historical data, regulatory requirements, or any other basis. For example, where an expected redemption rate is 80%, but historical data indicates that the highest historical redemption rate is 87%, the computing device 600 may assign a maximum redemption rate of 87%. Alternatively, the computing device 600 may statistically model the possible range of redemption rates, and determine to a level of confidence (99%, 95%, within 3 standard deviations, etc.) that redemptions are not expected to exceed 90% in any instance, and thus assign a maximum redemption rate of 90%. In some instances, the computing device 600 may age an account, so that a maximum redemption rate may vary over time. For example, when the printable payment instrument 120 is conveyed to a transferee, a maximum redemption rate of 90% may be assigned. However, for printable payment instruments 120 that have been conveyed to a transferee more than 6 months ago, a maximum redemption rate of 15% may be assigned. In some embodiments, a plurality of redemption rates will be combined to generate a composite redemption rate, which may determine the funding which may be transferred to support a plurality of planned payments. In some cases, the plurality of payments may vary across time, account types 310, transferees, etc.

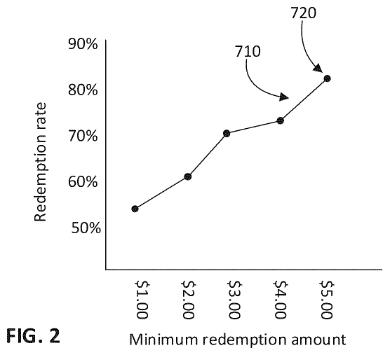

Turning to FIG. 2, a redemption rate curve 710 is depicted. The redemption rate curve 710 of FIG. 2 is determined by linear interpolation between a plurality of redemption rate data points 720. In some embodiments, the redemption rate curve 710 may be formed in other ways, such as by the application of smoothing algorithms, or otherwise determining a best-fit function. In some embodiments, a minimum redemption threshold 110 may vary based on an account type 310. In some embodiments, the minimum redemption threshold 110 may depend on the account type 310, based, for example, on the non-redemption costs incurred in the event of a non-redemption by the transferee. For example, an escrow account in a country with relatively high compliance costs may be assigned a higher minimum redemption threshold 110 than a savings account in a country with relatively low compliance costs. In some embodiments, the minimum redemption threshold 110 may be based on the rate at which a transferee redeems a payment. For example, a class of transferees highly sensitive to audits and financial scrutiny may require a relatively low minimum redemption threshold 110 to guarantee a very high redemption rate. In some instances, these payment may be determined based on historic information. For example, if medical providers routinely redeem payments for as little as $0.25, while small businesses routinely fail to redeem payments for as much as $2, then small businesses may require a higher minimum redemption threshold 110 than medical providers. In some embodiments, a target redemption rate may be set, such as by government regulation, or an internal goal. In some embodiments, the dynamic minimum redemption threshold 110 may be based on a target redemption rate. In some embodiments, a plurality of minimum redemption thresholds 110 may be randomly used, and, based on the redemption rates for each amount, a redemption rate curve 710 may be calculated. In some embodiments, a redemption rate curve 710 may comprise only data points, without any interpolation in between them. For example, a redemption rate curve 710 based on a conveyance service (e.g. U.S. mail, Federal Express, courier service, e-mail) may not contain interpolated lines, but may nonetheless show the various redemption rates for a plurality of options.

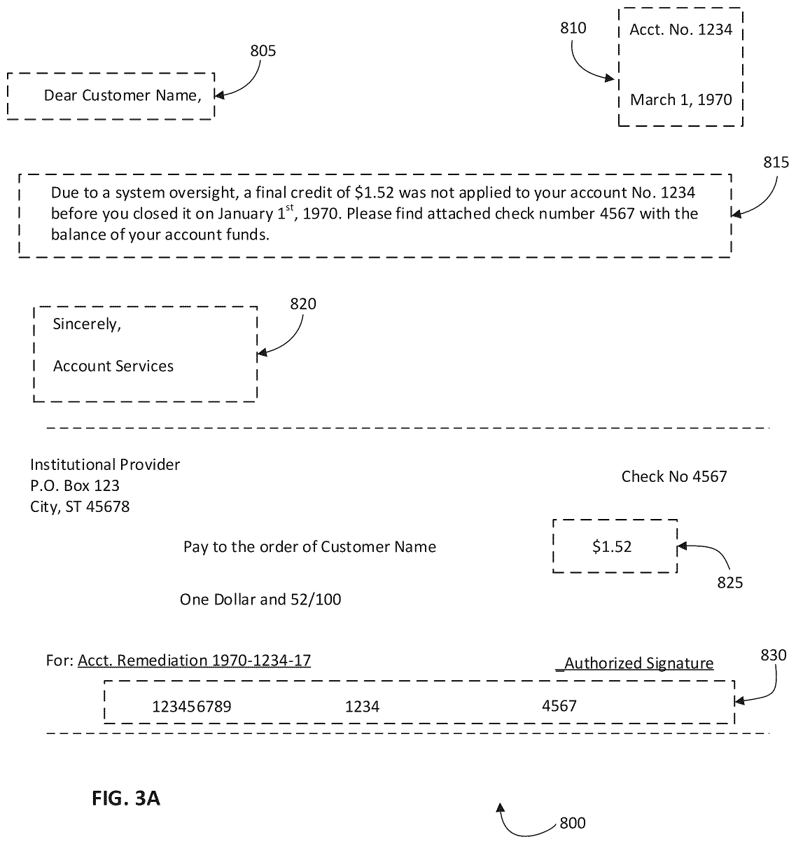

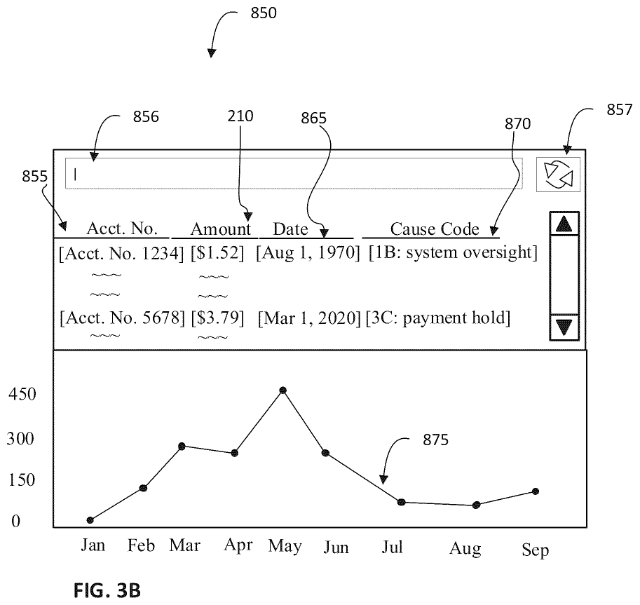

Turning to FIG. 3A, an exemplary transferee letter 410 is presented. The transferee letter 410 contains a salutation (e.g. dear Customer Name), which may aid in determining a customer name associated with the account. In some embodiments, the transferee letter 410 may be stored as a plurality of fields, which, beneficially, may aid in identifying the salutation, such as according to a field name. In other embodiments, the transferee letter 410 may be stored in another format, such as a pdf or a tiff. In some instances, it may be necessary to perform optical character recognition on the transferee letter 410 in order to determine the content of the transferee letter 410. It may be beneficial to identify zones of the transferee letter 410. The transferee letter 410 may include a salutation zone 805, which may contain information regarding an account holder, or an account representative. A vision system, which may be used in conjunction with a machine learning engine 520 and/or an NLP engine 510 may identify the customer name by, for example, an introduction (e.g. dear, C/O, valued customer, etc.), a position on a transferee letter 410 (such as in the upper left portion), etc. In some embodiments, the determination of a zone, such as a salutation zone 805, may aid in optical recognition, such as by weighting the optical character recognition system towards the identification of letters, rather than numbers in a salutation field, which, advantageously, may aid in determining names. For example, when used in conjunction with an NLP engine 510, a more accurate identification may aid in determining a name. In some embodiments, the NLP engine 510 or machine learning engine 520 may also rely on information being located in a zone, such as the salutation zone 805, to generate a match score. The transferee letter 410 may also contain a header zone 810 which may contain an account number, a date, a document control number, etc. In some embodiments, information in the header zone 810 may contain known information, or information of a known format. In some embodiments, the header information may refer to the metadata associated with an electronic record. In some embodiments, the header zone 810 information may be located in any other zone, such as a footer zone.

The transferee letter 410 may also contain a body zone 815, which may contain any of the information contained in various other fields, as well as relatively large text strings, or information stored in a format from which text strings can be derived. Text string may be processed by an NLP engine 510 to derive information, such as a cause code of a remediation payment. For example, an NLP engine 510 may indicate that a “system oversight” is the cause of a payment associated with the transferee letter 410, and associate that cause with an applicable cause code. Further, the information within the body zone 815 may repeat information located in other zones of the transferee letter 410. For example, the body zone 815 may indicate an initial payment amount 210. In some embodiments, the body zone 815 may contain a minimum redemption threshold 110. For example, the body zone 815 may recite both an initial payment amount 210, as well as the initial payment amount 210 (e.g. explaining the amount of the printable payment instrument 120). In some embodiments, the initial payment amount 210 and/or the minimum redemption threshold 110 may appear elsewhere on a transferee letter 410. In various embodiments, analysis and/or processing by interpretation engine 500 and/or an OCR system may be informed by information from various databases (e.g., payment information database 200, account information database 300, and/or notational database 400), such as check memo line 240 from the payment information database 200. Advantageously, this may aid an OCR system in determining a portion of a text string, or increasing a confidence of a match. For example, if the transferee letter 410 references an initial payment amount 210 of $1.52 in the body zone 815, and this amount is repeated on a printable payment instrument 120 (or account statement, etc.) then the OCR or NLP engine 510 may rely on the repeated similar value to determine a value of a character (e.g. to differentiate a ‘1’ from a ‘7’). Advantageously, this may lead to reliable detection of repeated fields, especially in transferee letters 410 containing imperfections (e.g. smudges, digital artifacts, etc.).

The transferee letter 410 may also contain a signature block zone 820, which may be useful in determining a sender. For example, the signature block may identify a business unit, a branch location, a specific employee, a company, etc. In some embodiments other portions of the transferee letter 410 may be useful in determining a sender. For example, header information, letterhead, return addresses, or payees listed on a printable payment instrument 120 may be useful in determining or confirming a sender. A transferee letter 410 may also include a printable payment instrument 120 which may include additional zones. For example, a check may include a payment amount zone 825, which may be used to determine a planned payment amount (which may be compared to a minimum redemption threshold 110, an initial payment amount 210, etc.). A check may further comprise account, routing, and check number information, for example, disposed along a bottom edge zone 830 of a paper check. A check (or other printable payment instrument 120) may further comprise barcodes, (e.g. QR codes). A transferee letter 410 may be described throughout by reference to FIG. 3A, and that the same techniques may be applicable to other data types, for example, any other data in the notational database 400. For example, an electronic communication may have one or more zones associated with associated metadata, and one or more zones associated with a payload. For example, an email may have to field zone, a subject zone, a salutation zone 805, a time zone, a traceroute zone, etc. In some embodiments, based on a prediction or prior determinations of which zones are likely to have certain data being sought, OCR and/or analysis may be limited to a certain subset of zones deemed to be relevant (rather than all zones of, e.g., an image), further enhancing computing efficiency.

FIG. 3B depicts one illustrative embodiment of a user presentment interface 850 (e.g., a virtual dashboard) associated with a plurality of planned payments from the payment information database 200. The user presentment interface 850 may display a transferee ID 250 such as a linking account number 855. In some embodiments, the displayed transferee ID 250 may be a name, address, etc. In some embodiments, a transferee may not be displayed in one or more of the screens of the user presentment interface 850. For example, a linking account number 855 may be displayed only when a transaction is selected (e.g. by a computer mouse or keyboard). In some embodiments, a user may have limited access to linked documents according to a user access controls or security protocols. For example, a user could be prevented from accessing personally identifiable information of accounts with associated addresses within a geographic boundary, or based on a business unit. In some embodiments, the user presentment interface 850 may include an initial payment amount 210. The initial payment amount 210 may be displayed as text, or in graphical form. For example, a chart may be displayed showing the number of planned payments according to their amounts.

In some embodiments, the user presentment interface 850 may contain a link (e.g. a hyperlink) to a document (e.g. a document contained in the notational database 400) which may allow a user of the user presentment interface 850 to access the document, such as to confirm an association of the NLP engine 510. In some embodiments, a cause code may be displayed by the user presentment interface 850 which may aid a user in confirming the determination of the interpretation engine 500. For example, the cause code may be displayed, and a user may select a data source the cause code is based on (e.g. a document of the notational database 400). In some embodiments, a user may wish to track remediation payments less than the minimum redemption threshold 110 (or, in some embodiments, all payments) over time. In one embodiment, the user presentment interface 850 may provide a graphical display of payments over time 875. Beneficially, this may enable a user to identify trends, concern areas, etc. In some embodiments, the graphical display of payments over time 875 may be divided, such as by business unit, by cause code, etc. Advantageously, such embodiments may enable a user to more immediately identify trends or concerns within a class of data, that may not be as readily apparent from a larger data set. In some instances, the user presentment interface 850 may contain a plurality of inter-related displays. For example, selecting a time period from the graphical display of payments over time 875 may display a list of the associated payments. Further, selecting an entry of the list may display the source of that information. For example, for a cause code which is determined based an interpretation engine 500, selecting the cause code may display the document (e.g. selecting the 1B cause code may cause the user presentment interface 850 to display FIG. 3A). In some embodiments, the original source document will be displayed as maintained in the notational database 400. In other embodiments, annotations (such as the marking of zones) may be present on the displayed source document, which, advantageously, may aid the user in interpreting the information, including any linkages.

In some embodiments, the user presentment interface 850 may contain controls such as a search bar 856 and a refresh button 857. The search bar 856 may enable a user to enter a search term which may be associated with the information presented in the user presentment interface 850. For example, a user may wish to search for records associated with a certain account number, or name. In some embodiments, entering a term in the search bar 856 may return results as a user inputs a search term (e.g. by a touch screen or keyboard). In other embodiments, a user may be required to activate a refresh button 857 after entering the search term to view results of a search. In some embodiments, the use of a refresh button 857 may (with or without a search term) update the current view with updated results.

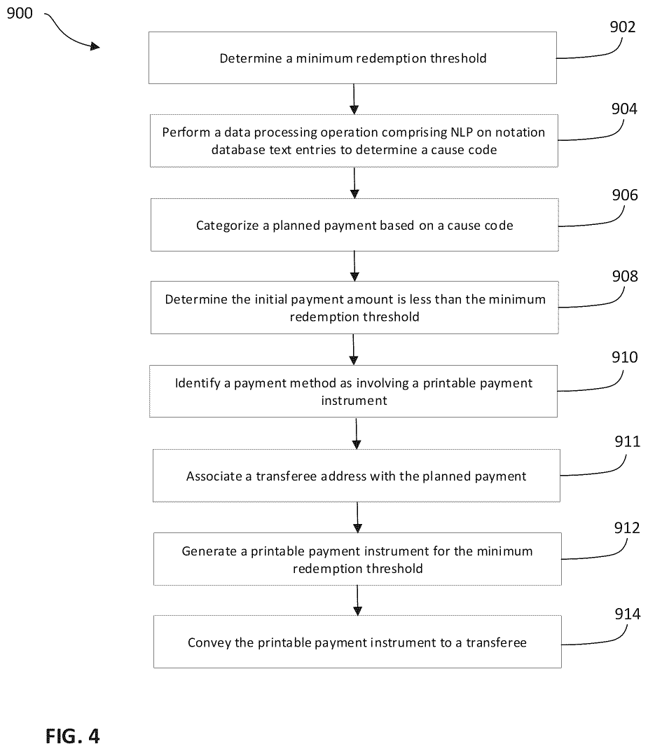

Turning to FIG. 4, a method 900 is depicted according to an illustrative embodiment. At 902, a minimum redemption threshold 110 is determined (e.g. based on a target redemption rate or a user input field). In some embodiments, the target redemption rate may vary according to a cause code, a campaign, etc. For example, the target redemption rate may vary according to the regulatory requirements associated with an account type 310 or geographic region. In some embodiments, the minimum redemption threshold 110 may also be set based on a target redemption date. For example, in some embodiments, a target redemption rate may be desired to be achieved according to schedule associated with the account closing (e.g. within 30 days, 60 days, 1 year). In other embodiments, a target redemption rate may be associated with a fixed deadline (e.g. the last day of a month, of a quarter, or before a regulatory reporting date). In some embodiments this target redemption rate may be based on past redemption data. For example, a payment amount of $5.00 may be historically correlated to a redemption rate of 90%, and thus, the minimum redemption threshold 110 may be determined as $5.00. In some embodiments, the minimum redemption threshold 110 may be based on past redemption data, but a different redemption amount may be selected. The change may be based on a desired redemption rate change, a redemption date change, differences between the accounts associated with the past redemption data and the accounts the minimum redemption threshold 110 is being determined for, prevailing economic conditions, etc. For example, if a past redemption data indicates that a redemption amount of $5.00 correlates with a redemption rate of 90%, and a target redemption rate of 95% is selected, then the minimum redemption threshold 110 may be adjusted. In another example, if past redemption data indicates that a redemption amount of $1.00 correlates with a redemption rate of 75%, and a target redemption rate of 75% is selected, the minimum payment amount may nonetheless be adjusted to account for inflation, prevailing economic conditions, and differences between account types 310. In some embodiments, the minimum redemption threshold 110 may be adjusted iteratively (e.g. continuously, daily, monthly, etc.) based on realized redemption rates.

At 904 a data processing operation comprising NLP on the text entries of the notational database to determine a cause code. In some embodiments, the data processing operation may comprise machine learning, image recognition/OCR, etc. In some embodiments, the cause code may be, or may be associated with, a payment type. In some embodiments, the cause code may be related to a root cause, a business unit, etc.

At 906 a planned payment is categorized according to a cause code. The cause code may be based on a payment type, which may be based off of a payment account, payment amount, information in a notational database 400, etc. In some cases, a cause code may be according to a compliance requirement, such an internal auditing control, a legal requirement, or pending litigation. In some embodiments, the cause code may relate to a root cause of the remediation payment. In some embodiments, the cause code may relate to a business group or unit. The cause code may be based on the account type 310, the transferee's place of residence, etc.

At 908, the initial payment amount 210 is determined to be less than a minimum redemption threshold. In some embodiments, comparing the initial payment amount may involve determining the applicability of the minimum redemption threshold 110 (in some cases, from a plurality of minimum redemption thresholds 110) to the planned payment. In some embodiments, the applicability of the minimum redemption threshold 110 may be based on the cause code. The categorization of the planned payment completed (e.g. step 906) may be useful in determining the applicability of the minimum redemption threshold 110. In some embodiments, the categorization (e.g. the assignment of a cause code) may be determinative of the applicability of a minimum redemption threshold 110. In other embodiments, the cause code may be relevant to the applicability of the minimum payment amount, but not determinative. For example, a cause code that indicates that a bank error is the root cause of a payment may be relevant to the applicability of the minimum redemption threshold 110. However, in some embodiments, the minimum redemption threshold 110 may not apply to currently-active accounts. In the provided example, for an active account with a previous bank error resulting in a planned payment (e.g. to the account), the minimum redemption threshold 110 may not be determined to apply to the planned payment, even where the cause code may be indicative of the applicability of the planned payment. Determining the applicability of the minimum redemption threshold 110 may be based on any of the factors that a cause code may be based on, with or without regard to the use of the factor determining the cause code for that embodiment. For example, in an embodiment where the cause code is not based on a transferee's state of occupancy, the applicability of the minimum redemption threshold 110 may be based on the state of occupancy of a transferee. Alternatively, where a cause code is based on a transferee's state of occupancy, the applicability of the minimum redemption threshold 110 may also be based on the transferee's state of occupancy.

At 910, a planned payment is identified as involving a printable payment instrument 120. In some embodiments, the payment may be identified according to a dedicated field. In other embodiments, the method of payment of the planned payment may be identified by a data processing operation, which may comprise the user of an interpretation engine 500 according to any of the disclosed methods here within, or variants thereof which may be implemented by one skilled in the art. At 911, a transferee address may be associated with the planned payment. In some embodiments, the address may comprise a postal mailing address, an email address, a bitcoin address, etc. The address may be associated based on a pre-existing database field or derived from, for example, the data processing operation utilizing the interpretation engine 500 in combination with a database.

At 912 a printable payment instrument 120 is generated, which is redeemable for the minimum redemption threshold 110. In some embodiments, the printable payment instrument 120 is a check. In some embodiments, the printable payment instrument 120 is a code (QR code, bitcoin address, etc.) configured to be accepted by scanning (e.g. by a mobile device) as well as capable of being printed. Advantageously, printing may increase contrast ratio, enable “air gap” security between devices, etc. At 914, the printable payment instrument 120 is conveyed to a transferee. In one embodiment, the printable payment instrument 120 is conveyed through an intermediary, such as a postal carrier, or a third party email server.

The embodiments described herein have been described with reference to drawings. The drawings illustrate certain details of specific embodiments that provide the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112 (f), unless the element is expressly recited using the phrase “means for.”

An exemplary system for providing the overall system or portions of the embodiments might include general purpose computing in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOCs) circuits, etc.), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory).

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure may be accomplished with standard programming techniques with rule based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and arrangement of the embodiments without departing from the scope of the present disclosure as expressed in the appended claims.

1. A system comprising:
a payment information database comprising a planned payment, wherein the planned payment comprises an initial payment amount to a transferee;
an account information database comprising account information of an account of the transferee;
a notational database comprising text entries and image data encoded to correlate the account information of the transferee in the account information database and the planned payment in the payment information database, the image data comprising a plurality of image formats captured using at least one camera;
a computing device comprising a processor and a memory comprising instructions executable by the processor and configured to cause the system to:
generate a redemption rate curve by executing a linear interpolation algorithm using a plurality of redemption rate data points from previous redemptions;
determine a minimum redemption threshold using the redemption rate curve and a specified target redemption rate;
categorize the planned payment as subject to the minimum redemption threshold based on:
(i) a cause code for the planned payment determined by executing a natural language processing model on the text entries in the notational database, the natural language processing model further identifying a transferee address and a transferor account number, and
(ii) an adjustment to the minimum redemption threshold calculated by executing a probabilistic model using the transferee address and the transferor account number as input;
execute a machine learning engine to determine a probability of the transferee address and a transferee account number being a match to the account of the transferee in the account information database, the probability determined based on:
identifying, from the image data, a set of zones using an optical character recognition process,
converting, from the image data, text information extracted using the optical character recognition process into the transferee account number having a computer-readable data type based on determining that the text information appears in at least two zones of the set of zones identified using the optical character recognition process, and
determining that the account of the transferee of the account information database matches the transferee account number;
determine that the initial payment amount of the planned payment in the payment information database is less than the minimum redemption threshold;
identify a payment method of the planned payment as involving a printable payment instrument;
responsive to the probability indicating the match to the account of the transferee in the account information database, associate the transferee address with the planned payment;
generate the printable payment instrument redeemable for the minimum redemption threshold; and
convey the printable payment instrument to the transferee at the transferee address.

2. The system of claim 1, wherein executing the natural language processing model further comprises identification of a zone based on optical recognition of a related image in the notational database.

3. The system of claim 2, wherein the zone corresponds with a position in an image file in the notational database.

4. The system of claim 2, wherein the zone is based on metadata corresponding to an electronic file or portion thereof.

5. The system of claim 4, wherein the electronic file is an image file.

6-7. (canceled)

8. The system of claim 1, wherein the minimum redemption threshold is based on a conveyance service of the printable payment instrument.

9. The system of claim 1, wherein the payment information database, the account information database, and the notational database are located on physically distinct computer readable media, and accessed by a plurality of processors across a network.

10. The system of claim 1, wherein the printable payment instrument is conveyed via an email message comprising a machine-readable code.

11. The system of claim 10, wherein the machine-readable code is a quick response (QR) code.

12. The system of claim 1, the instructions further causing the system to transfer excess payment funds to fund the minimum redemption threshold.

13. A method implemented by a system that comprises a payment information database with a planned payment to a transferee comprising an initial payment amount to the transferee, an account information database comprising account information of an account of the transferee, and a notational database comprising text entries and image data encoded to correlate with information the account information database and the payment information database, the image data comprising a plurality of image formats captured using at least one camera, the method comprising:
generating a redemption rate curve by executing a linear interpolation algorithm using a plurality of redemption rate data points from previous redemptions;
determining, by one or more processors of the system, a minimum redemption threshold using the redemption rate curve and a specified target redemption rate;
executing, by the one or more processors, a natural language processing model on the text entries in the notational database to determine a cause code for the planned payment, a transferee address, and a transferor account number;
executing, by the one or more processors, a machine learning engine to determine a probability of the transferee address and a transferee account number being a match to the account of the transferee in the account information database, the probability determined based on:
identifying, from the image data, a set of zones using an optical character recognition process,
converting, from the image data, text information extracted using the optical character recognition process into the transferee account number having a computer-readable data type based on determining that the text information appears in at least two zones of the set of zones identified using the optical character recognition process, and
determining that the account of the transferee of the account information database matches the transferee account number;
responsive to the probability indicating the match to the account of the transferee in the account information database, categorizing, by the one or more processors, the planned payment as subject to the minimum redemption threshold based on:
(i) the cause code for the planned payment, and
(ii) an adjustment to the minimum redemption threshold calculated by executing a probabilistic model using the transferee address and the transferor account number as input;
determining, by the one or more processors, that the initial payment amount of the planned payment in the payment information database is less than the minimum redemption threshold;
identifying, by the one or more processors, a payment method of the planned payment as involving a printable payment instrument;
associating, by the one or more processors, the transferee address with the planned payment;
generating, by the one or more processors, the printable payment instrument redeemable for the minimum redemption threshold; and
conveying, by the one or more processors, the printable payment instrument to the transferee at the transferee address.

14. The method of claim 13, wherein executing the natural language processing model further comprises identifying a zone based on optical recognition of a related image in the notational database.

15. The method of claim 14, wherein the zone corresponds with a position in an image file in the notational database.

16. The method of claim 14, wherein the zone is based on metadata corresponding to an electronic file or portion thereof.

17-18. (canceled)

19. The method of claim 13, wherein the printable payment instrument is conveyed via an email message comprising a machine-readable code.

20. A non-transitory computer readable medium having stored thereon instructions that, when executed by a computing system, cause the computing system to perform operations, wherein the computing system comprises a payment information database with a planned payment comprising an initial payment amount to a transferee, an account information database comprising account information of an account of the transferee, and a notational database comprising text entries and image data encoded to correlate with information contained in the account information database and the payment information database, the image data comprising a plurality of image formats captured using at least one camera, the operations comprising:
generating a redemption rate curve by executing a linear interpolation algorithm using a plurality of redemption rate data points from previous redemptions;
determining a minimum redemption threshold using the redemption rate curve and a specified target redemption rate;
executing a natural language processing model on the text entries in the notational database to determine a cause code for the planned payment, a transferee address, and a transferor account number;
executing a machine learning engine to determine a probability of the transferee address and the transferee account number being a match to the account of the transferee in the account information database, the probability determined based on:
identifying, from the image data, a set of zones using an optical character recognition process,
converting, from the image data, text information extracted using the optical character recognition process into the transferee account number having a computer-readable data type based on determining that the text information appears in at least two zones of the set of zones identified using the optical character recognition process, and
determining that the account of the transferee of the account information database matches the transferee account number;
responsive to the probability indicating the match to the account in the account information database, categorizing the planned payment as subject to the minimum redemption threshold based on:
(i) the cause code for the planned payment, and
(ii) an adjustment to the minimum redemption threshold calculated by executing a probabilistic model using the transferee address and the transferor account number as input;
determining that the initial payment amount of the planned payment in the payment information database is less than the minimum redemption threshold;
identifying a payment method of the planned payment as involving a printable payment instrument;
associating the transferee address with the planned payment;
generating the printable payment instrument redeemable for the minimum redemption threshold; and
conveying the printable payment instrument to the transferee at the transferee address.
